(19) United States
(12) Patent Application Publication
(10) Pub. No.: US 2017/0193869 A1
(43) Pub. Date: Jul. 6, 2017

(54) METHOD AND ELECTRONIC DEVICE FOR PROJECTED IMAGE PROCESSING

(71) Applicant: Lenovo (Beijing) Limited, Beijing (CN)

(72) Inventors: Jianjun Zhi, Beijing (CN); Qiang Zhang, Beijing (CN); Jiangwei Zhong, Beijing (CN); Jianguo Li, Beijing (CN)

(21) Appl. No.: 15/397,971

(22) Filed: Jan. 4, 2017

(30) Foreign Application Priority Data
Jan. 4, 2016 (CN) 201610004521.3
Jan. 4, 2016 (CN) 201610005997.9

(51) Int. Cl. G09G 3/00; G06K 9/00; G06F 3/01; G09G 3/02; G09G 5/02

(52) U.S. Cl. CPC G09G 3/002; G09G 3/02; G09G 5/02; G06F 3/017; G06K 9/00355

(57) ABSTRACT

A method and two variations of an electronic device are disclosed. The method includes acquiring target image data; obtaining first image information; acquiring preset image data; projecting first image information; acquiring the target image; and acquiring a detected image. The first device includes: a processing unit that acquires and processes target image data, obtains first image information, acquires preset image data and acquires detected image information; a first emission unit that projects the first image information; a second emission unit that projects the detected image information; and a display unit that acquires the target image and presents the target image and the detected image. The second device includes: a first emission unit that acquires and projects first image information; a second emission unit that acquires and projects preset image data; and a processing unit that obtains a target image and presents the target image and the detected image.

### FIELD

The present application is related to control technology, and specifically to a method and two variations of an electronic device.

### BACKGROUND

Currently, images can be projected by a mini projector, and gestures of a user can be recognized in an interactive projecting interface. In existing methods, output of three kinds of colors, red (R), green (G) and blue (B), can be controlled using a micro-electro-mechanical system (MEMS) to form a colorful image pattern. Another fixed image pattern is presented at the same time as the colorful image pattern and is captured using a gathering apparatus, forming the interactive projecting interface in which gestures can be recognized.

In the existing method, the image pattern is usually fixed, and, therefore, the gesture recognition algorithm is fixed, and a high amount of power is consumed by the algorithm regardless of the distance between the interactive projecting interface and the mini projector.

### SUMMARY

A method and two variations of a device are disclosed.

The method includes: acquiring and processing data of a target image; obtaining first image information; acquiring preset image data; projecting the first image information using a first light source; acquiring the target image corresponding to the first image information; and acquiring a detected image corresponding to the preset image data.

The first device includes: a processing unit that acquires and processes data of a target image, obtains first image information comprising a first color bit and second image information comprising a second color bit, acquires preset image data, and acquires detected image information after processing the preset image data and the second image information; a first emission unit that projects the first image information using a first light source; a second emission unit that projects the detected image information using a second light source with a wavelength parameter meeting a preset condition; and a display unit that acquires the target image corresponding to the first image information and the detected image corresponding to the preset image data, and presents the target image and the detected image in a first area outside the electronic device.

The second device includes: a first emission unit that acquires first image information, and projects, using a first light source, the first image information; a second emission unit that acquires preset image data and projects the acquired preset image data using a second light source whose wavelength parameter meets a preset condition; and a processing unit that obtains a target image corresponding to the first image information and a detected image corresponding to the preset image data, and presents the target image and the detected image in a first area outside the electronic device.

### BRIEF DESCRIPTION OF THE DRAWINGS

To describe the technical solutions more clearly, accompanying drawings used for describing the embodiments are hereinafter briefly introduced. The accompanying drawings are only intended to illustrate some of the many possible embodiments.

FIG. 1 is a schematic flow diagram for implementing one embodiment of a control method;

FIG. 2 is a schematic diagram depicting the principle for projecting data of a first image in one embodiment;

FIG. 3 is a schematic diagram depicting the projecting principle for existing mini laser projection;

FIG. 4 is a schematic diagram depicting the principle of a control method in one embodiment;

FIG. 5 is a schematic flow diagram for implementing one embodiment of a control method;

FIG. 6 is a schematic flow diagram for implementing one embodiment of a control method;

FIG. 7 is a schematic structural diagram of one embodiment of an electronic device;

FIG. 8 is a schematic structural diagram of one embodiment of an electronic device; and

FIG. 9 is a specific schematic structural diagram of one embodiment of an electronic device.

### DETAILED DESCRIPTION

In order to understand the characteristics and technical contents of the embodiments in greater detail, reference is made to the accompanying drawings; wherein the drawings are used for reference and explanation, rather than to limit the embodiments

One embodiment will now be described.

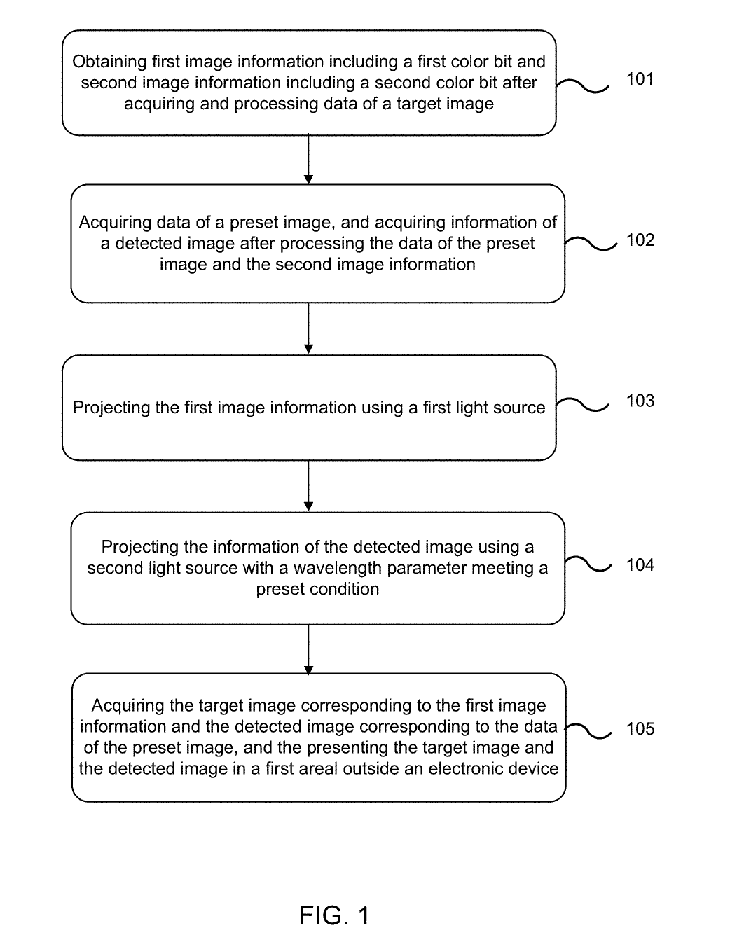

FIG. 1 is a schematic flow diagram 1 for implementing a control method in one embodiment. As shown in FIG. 1, the method is applied to an electronic device.

Step 101 comprises obtaining first image information including a first color bit and second image information including a second color bit after acquiring and processing data of a target image.

In this embodiment, the electronic device comprises a notebook computer or a smart phone. The electronic device can also comprise a wearable device, such as a smart watch, a smart band, smart glasses, smart earphones, or other devices capable of processing the data.

In this embodiment, the data of the target image, the first image information and the second image information are images formed by three RGB primary colors (red, green and blue) having different color bits. In one example, the data of the target image comprises a 24-bit image corresponding to RGB888, the first image information comprises an 18-bit image corresponding to RGB666, and the second image information comprises a 6-bit image corresponding to RGB222. That is, the data of the target image corresponding to RGB888 is divided into the first image information corresponding to RGB666 and the second image information corresponding to RGB222 by the electronic device. All image information of the data of the target image corresponding to RGB888 is loaded into the first image information corresponding to RGB666, and only the color fidelity is reduced due to the reduction in bit depth. In this way, a foundation is laid for loading data of a preset image into the second image information on the basis that the target image corresponding to an image of the target data is ensured to present.

Step 102 comprises acquiring the data of the preset image, and acquiring information of a detected image after processing the data of the preset image and the second image information.

In actual application, the electronic device can be used to acquire information of the detected image capable of representing the data of the preset image after loading the acquired data of the preset image in at least one group of data units selected from the second color bit of the second image information. For example, the electronic device can be used to acquire the information of the detected image capable of representing the data of the preset image after loading the data of the preset image in a single bit selected from the second color bit of the second image information.

Step 103 comprises projecting the first image information using a first light source.

In one embodiment, the first light source is formed by three RGB primary colors (red, green and blue). That is, the first image information is projected by the electronic device using the first light source formed by three RGB primary colors. The target image corresponding to the data of the target image (that is, the target image of the first image information) can be acquired when the first image information is projected by the electronic device using the first light source because all image information of the data of the target image is carried by the first image information.

Step 104 comprises projecting the information of the detected image using a second light source with a wavelength parameter meeting a preset condition.

In this embodiment, the wavelength of the second light source is specifically limited by the preset condition to be within a wavelength range corresponding to invisible light. For example, in some embodiments, the second light source can comprise an infrared laser. In this embodiment, the electronic device uses the second light source (that uses invisible light) to project the information of the detected image so as to project the detected image corresponding to the information of the detected image. The detected image can also be the image corresponding to the preset image data because the information of the detected image information can produce the image information of the preset image data.

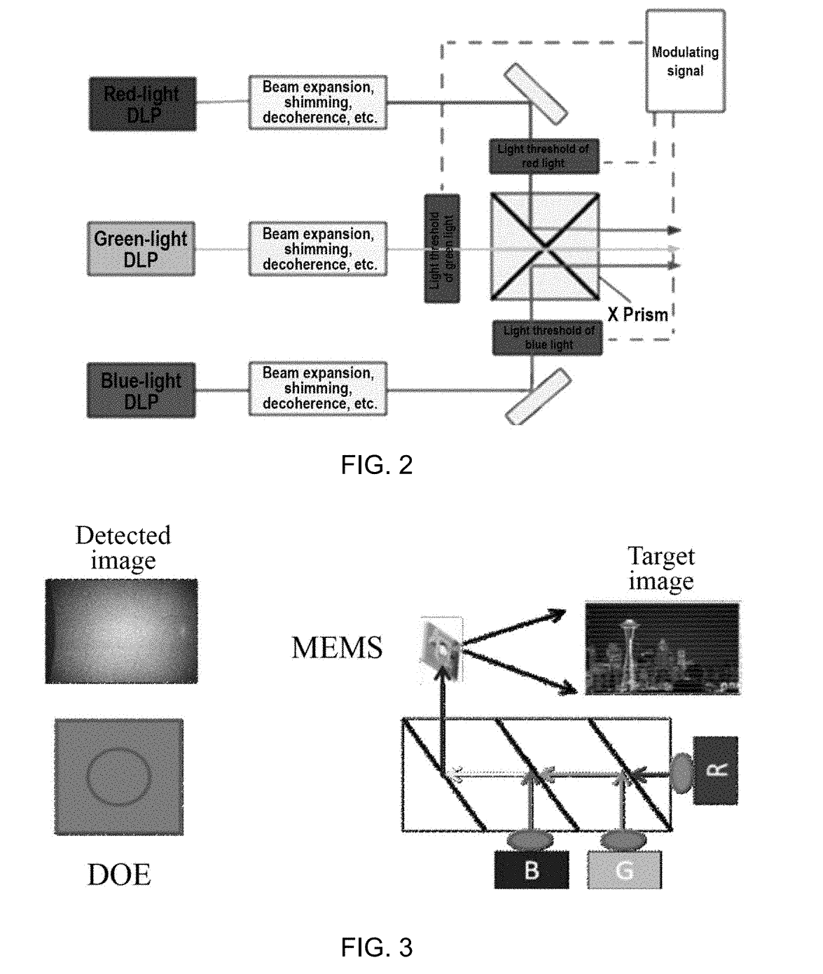

In this embodiment, a specific process of projecting the first image information using the first light source corresponding to the three RGB primary colors is shown in FIG. 2. The first image information is projected using a red-light digital light processing device (DLP), a green-light DLP device and a blue-light DLP device.

Step 105 comprises acquiring the target image corresponding to the first image information and the detected image corresponding to the preset image data, and presenting the target image and the detected image in a first area outside the electronic device.

In application, the data of the preset image comprises image data set in advance based on actual needs. For example, the data of the preset image can be a dynamic image pattern, such as a lattice diagram. In one specific embodiment, the data of the preset image is detected by the electronic device before step 104 in order to project the information of the detected image using the second light source with the wavelength parameter meeting the preset condition using a first emission power after acquiring pixel features of the data of the preset image and confirming the first emission power matching the data of the preset image based on the pixel features of the data of the preset image. That is, an emission power of the second light source can be confirmed by the electronic device based on the pixel features of the data of the preset image. In this way, a foundation can be laid for recognizing user operations while adapting to different environments and different conditions.

In this embodiment, an interactive projecting interface capable of recognizing the user operations is presented by the detected image. The information of the detected image is also the dynamic image pattern because the data of the preset image is the dynamic image pattern. Furthermore, the detected image can specifically be the dynamic image pattern corresponding to the data of the preset image and the information of the detected image, such as the lattice diagram, because the dynamic image Patten can specifically be the lattice diagram.

The following further explains one embodiment in detail by describing a specific application scenario.

FIG. 3 is a schematic diagram depicting the projecting principle for existing mini laser projection. As shown in FIG. 3, in mini laser projection, a traditional method uses a MEMS (micro electro-mechanical system) to control output of three RGB primary colors to create a final combination of a colorful image, and the fixed image pattern is generated by one diffractive optical element (DOE). If the fixed image pattern is compatible with close range recognition of the user operations, then the user operations cannot be recognized when the distance from the interactive projecting interface to the mini projector is extended because the image pattern is fixed. Furthermore, even if the fixed image pattern can support long range recognition of user operations (and can obviously support close range recognition of the user operations), a recognition algorithm cannot be integrated on the mobile device due to complexity and high power consumption. Furthermore, the cost is increased because multiple DOEs are required if long range recognition and close range recognition are implemented by different fixed image patterns, and the difficulty of design layout is increased because layout of the DOE is closely related to coverage of a light path. Therefore, application of mini laser projection on mobile devices is limited by the existing method.

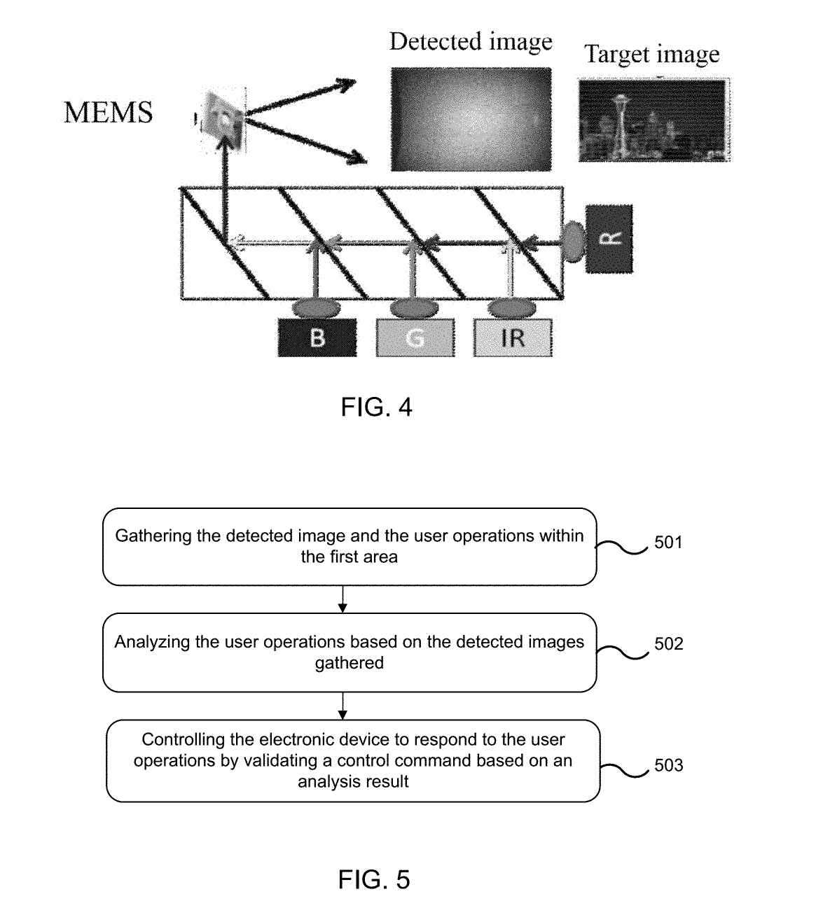

FIG. 4 is a schematic diagram depicting the principle of the control method of one embodiment. As shown in FIG. 4, the data of the former target image formed by three RGB primary colors is divided into two parts in one embodiment of the control method of the embodiment. One part is taken as the first image information having the first color bit, and the other part is taken as the second image information having the second color bit, wherein the first color bit is higher than the second color bit, thereby allowing all of the image information of the data of the target image to be loaded into the first image information and loading the data acquired from the preset image in the second image information so that the information of the detected image can be acquired.

The first image information is projected by the electronic device using the first light source, and the information of the detected image is projected by the second light source. That is, the information of the detected image is projected by adding one path of the second light source (such as an infrared laser), while the first image information is projected using the first light source corresponding to the former three RGB primary colors so that the target image and the detected image are acquired. In this way, a foundation is laid for recognizing the user operations using the detected image. Specifically, the target image and the detected image are acquired after time-sharing screening of the first light source and the second light source (that is, four paths of light sources using the MEMS).

Because the wavelength of the second light source is limited to the wavelength range of invisible light, projection of the information of the detected image using a newly added path of the second light source will not influence display of the target. Furthermore, because the information of the detected image is projected by the second light source as per the control method, different sets of data of the preset image having different pixel features can be selected in different embodiments based on the recognition requirements (such as short range and long range recognition requirements). Also, the detected image can be acquired after the information of the detected image corresponding to the data of the preset image matching the recognition requirements of the user operations is projected using the second light source.

Since short range and long range recognitions can be implemented by adjusting the pixel features of the data of the preset image, power can be saved when different optimization algorithms are adopted based on different distances presented. At the same time, the control method can be applied to a mobile device because the recognition algorithm can be optimized based on the different distances.

The infrared laser is controlled by the MEMS to output different dynamic image patterns. Here, when a dot matrix of the dynamic image pattern is arranged less densely, the electronic device for implementing the control method can be used to recognize user operations within a short range, and when the dot matrix of the dynamic image pattern is arranged more densely, the electronic device for implementing the control method can be used for recognizing user operations within a long range.

Also, the first light source and the second light source can be overlapped, and in this way, recognition precision is improved.

The information of the detected image can be acquired after decomposing the data of the target image into the first image information (including the first color bit) and the second image information (including the second color bit) and loading the data of the preset image using the second image information as to acquire the target image corresponding to the first image information, as well as the detected image corresponding to the data of the preset image by projecting the first image information through the first light source and projecting the information of the detected image through the second light source. Therefore, the purpose of presenting the detected image can be achieved when presenting the target image, and a foundation is laid for recognizing the user operations using the detected image.

Because the detected image is presented by the projection of the information of the detected image by the second light source, and the information of the detected image can present the image information of the data of the preset image, different data of the preset image can be selected based on the recognition requirements (such as short range and long range recognition requirements) required by actual conditions in order to acquire the detected image by projecting, through the second light source, the information of the detected image corresponding to the data of the preset image matching the recognition requirements of the user operations. Therefore, automatic adaptation for short range and long range detection can be implemented, the recognition algorithm can be optimized, and power consumption can be reduced.

Another embodiment will now be described.

Some embodiments additionally comprise the following Steps 501, 502, and 503, as shown in FIG. 5, after step 105.

Step 501 comprises gathering the detected image and the user operations within the first area. Step 502 comprises analyzing the user operations based on the detected image gathered. Step 503 comprises controlling the electronic device to respond to the user operations by validating a control command based on an analysis result.

The electronic device can be used to confirm features of user operations with respect to the detected image by gathering the detected image using a gathering unit thereby gathering the user operations within the first area. For example, user operations can be used to form a control command using 3D coordinates corresponding to the detected image, and the electronic device can be controlled to respond to user operations. The analysis result can specifically comprise the 3D coordinate information of user operations with respect to the detected image.

Another embodiment will now be described.

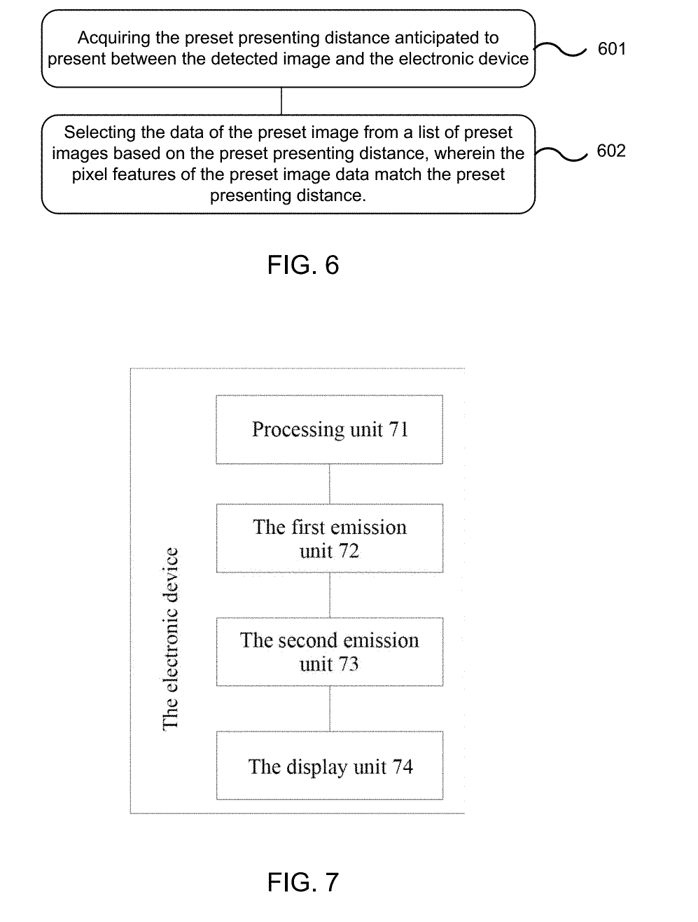

Based the control method in embodiments previously described, the electronic device in this embodiment can be used for selecting the data of the preset image matching a preset presenting distance. Thus, the detected image is presented, and a foundation is laid for simplifying the recognition algorithm. In this embodiment, the control method further comprises the following steps as shown in FIG. 6.

Step 601 comprises acquiring the preset presenting distance between the detected image expected to be present and the electronic device.

In this embodiment, the process of acquiring the preset presenting distance can be acquired by user operations. For example, a number directly input by the user shall be set as the preset presenting distance by the electronic device. Alternatively, the preset presenting distance can be confirmed directly by the electronic device by laser ranging. For example, when the user projects the detected image to a first screen of the electronic device, the distance between the electronic device and the first screen can be detected by the electronic device in the by laser ranging, and the preset presenting distance can be set based on a detection result. The method of acquiring the preset presenting distance is not limited to these specific examples. Moreover, the electronic device can be used for confirming the preset presenting distance based on any detection method available in actual application.

Step 602 comprises selecting the data of the preset image from a list of preset images based on the preset presenting distance, wherein the pixel features of the data of the preset image match the preset presenting distance.

In this embodiment, the list of the preset images is set in the electronic device before step 601. The data of the preset images with different pixel features is stored in the list of the preset images to facilitate selection of the data of the preset images matching the presenting distance by the electronic device.

Steps 601 and 602 are implemented before processing the information of the detected image using the second light source in actual application.

Furthermore, the electronic device is also used for confirming a second emission power based on the data of the preset image and the preset presenting distance in actual application. Therefore, the information of the detected image can be projected using the second light source with the wavelength parameter meeting the preset condition in the presence of the second emission power. In this way, the pixel features of the detected image can be adjusted by adjusting the emission power to lay a foundation for a recognition process of the user operations while adapting to different environments and different conditions.

Another embodiment will now be described.

FIG. 7 is a schematic structural diagram of one embodiment of an electronic device. As shown in FIG. 7, the electronic device comprises: a processing unit 71 for acquiring first image information including a first color bit and second image information including a second color bit after acquiring and processing data of a target image, as well as acquiring data of a preset image, and acquiring information of a detected image after processing the data of the preset image and the second image information; a first emission unit 72 for projecting the first image information using a first light source; a second emission unit 73 for projecting the information of the detected image using a second light source with a wavelength parameter meeting a preset condition; and a display unit 74 for acquiring the target image corresponding to the first image information and the detected image corresponding to the data of the preset image, and presenting the target image and the detected image in a first area outside the electronic device.

In this embodiment, the processing unit 71 is also used for acquiring the information of the detected image representing the data of the preset image after loading the data of the preset image in at least one group of data units selected from the second color bit of the second image information.

In this embodiment, the processing unit 71 is also used for detecting the data of the preset image to acquire pixel features of the data of the preset image, as well as for validating a first emission power matching the data of the preset image based on the pixel features of the data of the preset image. The second emission unit 73 is also used for projecting the information of the detected image using the second light source with a wavelength parameter meeting the preset condition in presence of the first emission power.

Those skilled in the art will understand the functions of all processing units in the electronic device in the embodiments with reference to relevant descriptions of the above-mentioned control method, and functions thereof shall not be repeated here. Moreover, all processing units in the electronic device of the embodiments can be implemented by a simulation circuit, or by running software by which the functions mentioned in the embodiments can be implemented on an intelligent terminal.

Another embodiment will now be described.

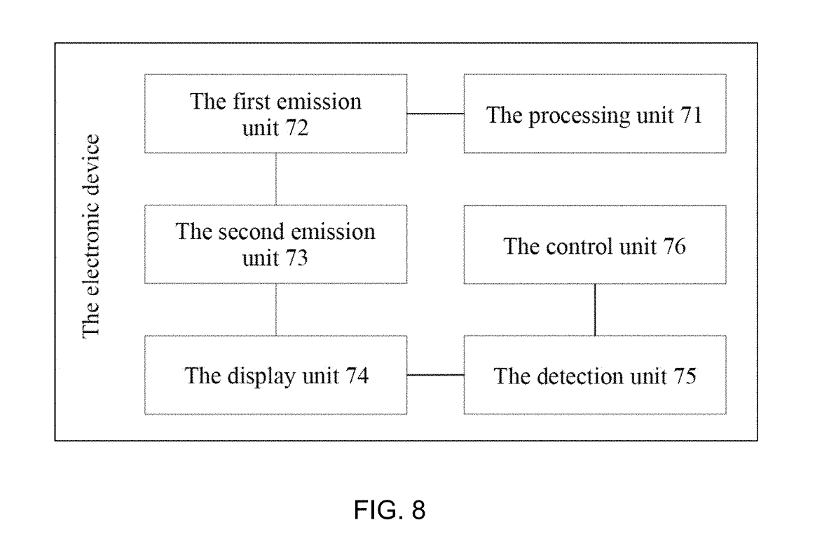

FIG. 8 is a schematic structural diagram of an electronic device of one embodiment. As shown in FIG. 8, the electronic device comprises: a processing unit 71 for obtaining first image information including a first color bit and second image information including a second color bit after acquiring and processing data of a target image, as well as acquiring data of a preset image, and acquiring information of a detected image after processing the data of the preset image and the second image information; a first emission unit 72 for projecting the first image information using a first light source; a second emission unit 73 for projecting the information of the detected image using a second light source with a wavelength parameter meeting a preset condition; a display unit 74 for acquiring the target image corresponding to the first image information and the detected image corresponding to the data of the preset image, and presenting the target image and the detected image in a first area outside the electronic device; a detection unit 75 for gathering the detected image and user operations within the first area; and a control unit 76 for analyzing the user operations based on the detected images gathered, and controlling the electronic device to respond to the user operations by validating a control command based on an analysis result.

In this embodiment, the processing unit 71 is also used for acquiring the information of the detected image capable of representing the data of the preset image after loading the data of the preset image in at least one group of data units selected from the second color bit of the second image information.

In this embodiment, the processing unit 71 is also used for detecting the data of the preset image in order to acquire pixel features of the data of the preset image, and validating a first emission power matching the data of the preset image based on the pixel features of the data of the preset image; and the second emission unit 73 is also used for projecting the information of the detected image using the second light source with the wavelength parameter meeting the preset condition in presence of the first emission power.

In this embodiment, the processing unit 71 is also used for acquiring a preset presenting distance between the detected image and the electronic device, and selecting the data of the preset image from a list of preset images based on the preset presenting distance, wherein the pixel features of the data of the preset image match the preset presenting distance.

In this embodiment, the processing unit 71 is used for confirming a second emission power based on the confirmed data of the preset image and the preset presenting distance. The second emission unit 73 is also used for projecting the information of the detected image using the second light source with a wavelength parameter meeting the preset condition in presence of the second emission power.

Those skilled in the art will understand the functions of all processing units in the electronic device with reference to relevant descriptions of the above-mentioned control method, and therefore the functions thereof shall not be repeated herein. Moreover, all processing units in the electronic device can be implemented by a simulation circuit for implementing the functions of the embodiments, or by running software by which the functions mentioned in the embodiments can be implemented on an intelligent terminal.

All units mentioned in the electronic device are schematically divided only in terms of logical function; and other division methods can be implemented. Another division method of the electronic device and a specific implementation process of the control method in embodiments by the electronic device under this division method shall be described below.

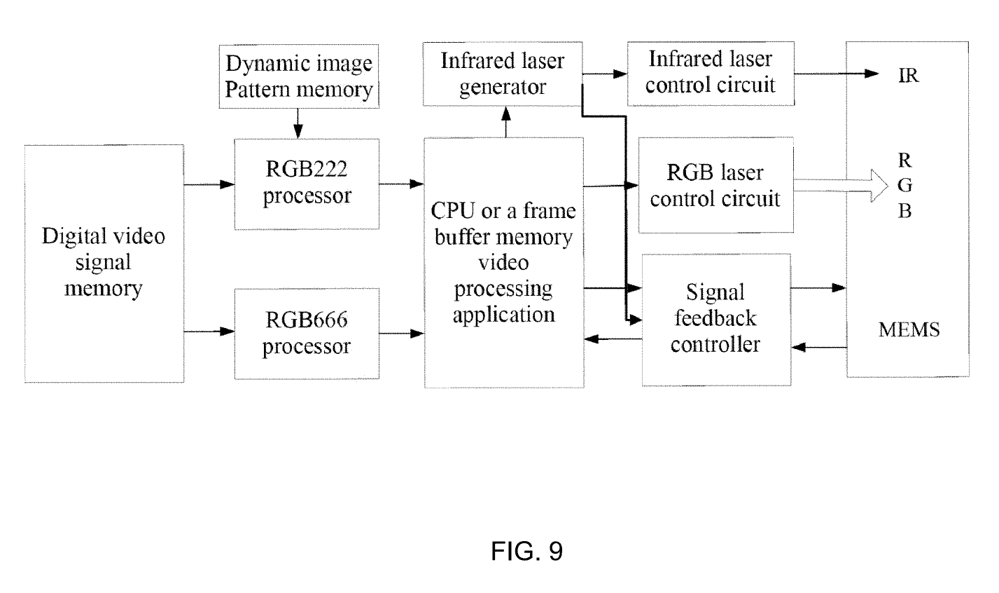

FIG. 9 is a specific schematic structural diagram of an electronic device of one embodiment. As shown in FIG. 9, the electronic device comprises a dynamic image pattern memory, an infrared laser generator, an infrared laser control circuit, a digital video signal memory, a RGB222 processor, a RGB666 processor, a central processing unit (CPU) or a frame buffer memory video processing application specific integrated circuit, a RGB laser control circuit, a signal feedback controller and a MEMS, wherein data of a target image is stored in a digital video signal memory in the electronic device as shown in FIG. 9.

As an example, suppose that data of the target image has 24-bit RGB888 image data. This RGB888 data can be divided into RGB666 and RGB222 by the digital video signal memory, wherein RGB666 shall still be processed based on a normal procedure, but the color shall be changed from true color to 260,000 colors. Specifically, a light source formed by three RGB primary colors is outputted from RGB666 after passing through the RGB666 processor, the CPU or the frame buffer memory video processing application specific integrated circuit and the RGB laser control circuit.

Meanwhile, at least one group of data units is selected by the RGB222 processor from RGB222 randomly. For example, one bit may be randomly selected as an IR laser input signal of the data of the preset image, and the data of the preset image acquired from the dynamic image pattern memory shall be taken as an input source of an IR laser drive image, wherein the input source of the IR laser drive image, or the data of the preset image, is loaded on the IR laser input signal. Therefore, the IR laser input signal can be output based on different duty cycles of the images including R, G, B and IR after being subjected to video processing and control by the CPU or the frame buffer memory video processing application specific integrated circuit and output to the MEMS by the infrared laser generator and the infrared laser control circuit.

The target image corresponding to the data of the target image and the detected image corresponding to the data of the preset image can be acquired after time-sharing screening of four paths of signals, including R, G, B and IR based on the logics of the MEMS, wherein the detected image shall be taken to recognize user operations. The target image is visible, while the detected image is invisible from the viewing perspective of the user even though the two images are available at the same time. Therefore, the user shall not be affected.

Also, the amount of stored data of the preset image can be confirmed based on the size of the dynamic image pattern memory. In this way, a foundation is laid for recognizing the user operation under different environments with different distances, as well as effectively reducing power consumption.

The signal feedback controller is used for receiving signal feedback information sent by the MEMS and sending the signal feedback information to the CPU or the frame buffer memory video processing application specific integrated circuit in order to facilitate adjustment of a time-sharing screening strategy of the MEMS based on the feedback information.

The device and the method disclosed can be implemented by other methods in different embodiments. All above-mentioned embodiments of the device are schematic only, in that the units are divided in terms of logical functions, and other division methods are allowable based on actual conditions. For example, multiple units or components can be combined or integrated into another system, or some features can be ignored or not implemented. Furthermore, coupling, direct coupling, or communication connection of all constituent parts displayed or discussed can be implemented by interfaces and the indirect coupling or communication connections of the device or the units can be implemented electrically, mechanically, or by other forms.

The above-mentioned units taken as separate parts may or may not be physically separated, and the divisions of units may or may not be physical units (that is, located at one place or distributed on multiple network elements). Moreover, the objectives of the various solutions in the embodiments can be implemented by selecting the units partially or completely based on actual needs.

Furthermore, all the functional units can be integrated in one processing unit completely, or taken as independent units, and multiple functional units can be integrated in one unit. Moreover, the units integrated can be implemented in the form of hardware, or in the form of a functional unit including hardware and software.

Those skilled in the art will understand that the steps for implementing the embodiments of the above-mentioned method can be completely or partially implemented by means of hardware related to a program command, and the above-mentioned program can be stored in a readable storage medium of one computer. The steps included in the embodiments of the method shall be implemented when implementing the program. The above-mentioned storage medium includes all kinds of media capable of storing program codes, such as a mobile storage device, a read only memory (ROM), random access memory (RAM), a disk or an optical disk, or other storage medium.

Alternatively, the above-mentioned units integrated in the embodiments can also be stored in the readable storage medium of a computer if it is implemented in the form of a functional module of the hardware. Based on this understanding, the parts substantially contributing to the technical solutions of the various embodiments can be presented in the form of a software product that is stored in the storage medium, partially or completely, including the parts driving one piece of computer equipment (personal computer, server, or network equipment, etc.) to implement the method in all embodiments by multiple commands. The above-mentioned storage medium includes all kinds of media capable of storing the program codes, such as the mobile storage device, the read only memory (ROM), the random-access memory (RAM), the disk or optical disk, etc.

The above contents encompass only some of the possible embodiments, and the scope of this disclosure is not limited thereto. Any changes or replacements that can be thought of or substituted easily by any person familiar in the art shall fall within the scope of the embodiments.

What is claimed is:

1. A method, comprising:
acquiring and processing data of a target image;
obtaining first image information;
acquiring preset image data;
projecting the first image information using a first light source;
acquiring the target image corresponding to the first image information; and
acquiring a detected image corresponding to the preset image data.

2. The method of claim 1, comprising:
obtaining second image information comprising a second color bit;
acquiring detected image information after processing the preset image data and the second image information;
projecting the detected image information using a second light source with a wavelength parameter meeting a preset condition; and
presenting the target image and the detected image in a first area outside an electronic device;
wherein the first image information comprises a first color bit.

3. The method of claim 2, wherein:
acquiring detected image information after processing the preset image data and the second information comprises:
acquiring the detected image information capable of representing the preset image data after loading the preset image data in at least one group of data units selected from the second color bit of the second image information.

4. The method of claim 2, further comprising:
gathering the detected image and user operations within the first area;
analyzing the user operations based on the detected image gathered; and
controlling the electronic device to respond to the user operations by validating a control command based on an analysis result.

5. The method of claim 2, further comprising:
analyzing the preset image data to acquire pixel features of the preset image data; and
validating a first emission power level corresponding to the preset image data based on the pixel features of the preset image data;
wherein
projecting the detected image information using a second light source with a wavelength parameter meeting a preset condition comprises projecting, at the first emission power level, the detected image information using a second light source with a wavelength parameter meeting a preset condition.

6. The method of claim 2, further comprising:
acquiring a preset presenting distance between the detected image and the electronic device; and
confirming a second emission power level based on the preset image data and the preset presenting distance;
wherein:
acquiring preset image data comprises selecting the preset image data from a group of possible preset image data based on the preset presenting distance,
pixel features of the preset image data correspond to the preset presenting distance, and
projecting the detected image information using a second light source with a wavelength parameter meeting a preset condition comprises projecting, at the second emission power level, the detected image information using a second light source with a wavelength parameter meeting a preset condition.

7. The method of claim 1, further comprising:
projecting the acquired preset image data using a second light source whose wavelength parameter meets a preset condition; and
presenting the target image and the detected image in a first area outside an electronic device.

8. The method of claim 7, further comprising:
collecting the detected image and a user operation in the first area;
parsing the user operation based on the collected detected image; and
determining a control instruction based on the parsing of the user operation to control the electronic device in response to the user operation.

9. The method of claim 7, further comprising:
analyzing the preset image data to acquire a pixel feature of the preset image data; and
determining, based on the pixel feature of the preset image data, a first emission power level corresponding to the preset image data;
wherein
projecting the acquired preset image data using a second light source whose wavelength parameter meets a preset condition comprises projecting, at the first emission power level, the acquired preset image data using a second light source whose wavelength parameter meets a preset condition.

10. The method of claim 7, further comprising:
acquiring a preset presenting distance between an anticipated presented image and the electronic device; and
determining a second projecting distance based on the selected preset image data and the preset presenting distance;
wherein
acquiring preset image data comprises selecting the preset image data from a group of possible preset image data based on the preset presenting distance,
pixel features of the preset image data correspond to the preset presenting distance, and
projecting the acquired preset image data using a second light source whose wavelength parameter meets a preset condition comprises projecting, at a second emission power level, the acquired preset image data using a second light source whose wavelength parameter meets a preset condition.

11. A device, comprising:
a processing unit that
acquires and processes data of a target image,
obtains first image information comprising a first color bit and second image information comprising a second color bit,
acquires preset image data, and
acquires detected image information after processing the preset image data and the second image information;
a first emission unit that projects the first image information using a first light source;
a second emission unit that projects the detected image information using a second light source with a wavelength parameter meeting a preset condition; and
a display unit that
acquires the target image corresponding to the first image information and the detected image corresponding to the preset image data, and
presents the target image and the detected image in a first area outside the electronic device.

12. The device of claim 11, wherein:
the processing unit acquires the detected image information after processing the preset image data and the second image information by:
acquiring detected image information that can represent the preset image data after loading the preset image data in at least one group of data units selected from the second color bit of the second image information.

13. The device of claim 11, further comprising:
a detection unit that gathers the detected image and user operations within the first area; and
a control unit that analyzes the user operations based on the gathered detected image and controls the electronic device to respond to the user operations by validating a control command based on an analysis result.

14. The device of claim 11, wherein:
the processing unit detects the preset image data to acquire pixel features of the preset image data, and validates a first emission power level corresponding to the preset image data based on the pixel features of the preset image data; and
the second emission unit projects the detected image information using the second light source with the wavelength parameter meeting the preset condition at the first emission power level.

15. The device of claim 11, wherein
the processing unit
acquires a preset presenting distance between the detected image and the electronic device,
acquires preset image data by selecting preset image data from a group of possible preset image data based on the preset presenting distance, wherein pixel features of the preset image data correspond to the preset presenting distance, and
confirms a second emission power level based on the preset image data and the preset presenting distance; and
the second emission unit projects the detected image information using the second light source with the wavelength parameter meeting the preset condition at the second emission power level.

16. A device, comprising:
a first emission unit that
acquires first image information, and
projects, using a first light source, the first image information;
a second emission unit that
acquires preset image data, and
projects the acquired preset image data using a second light source whose wavelength parameter meets a preset condition; and
a processing unit that
obtains a target image corresponding to the first image information and a detected image corresponding to the preset image data, and
presents the target image and the detected image in a first area outside the electronic device.

17. The device of claim 16, further comprising:
a collecting unit that collects the detected image and a user operation in the first area; and
a control unit that parses the user operation based on the collected detected image and determines a control instruction based on the parsing of the user operation to control the electronic device in responding to the user operation.

18. The device of claim 16, wherein
the second emission unit:
detects the preset image data and acquires a pixel feature of the preset image data;
determines, based on the pixel feature of the preset image data, a first projecting power level that matches the preset image data; and
projects, at the first projecting power level, the acquired preset image data using a second light source whose wavelength parameter meets a preset condition.

19. The device of claim 16, wherein
the second emission unit
acquires a preset presenting distance between an anticipated presented image and the electronic device; and
selects preset image data from a group of possible preset image data based on the preset presenting distance, wherein pixel features of the preset image data correspond to the preset presenting distance.

20. The device of claim 19, wherein
the second emission unit
determines a second projecting power level based on the determined preset image data, and
projects, at the second projecting power level, the acquired preset image data using a second light source whose wavelength parameter meets a preset condition.
